(19) United States
(12) Patent Application Publication
(10) Pub. No.: US 2026/0093978 A1
(43) Pub. Date: Apr. 2, 2026

(54) MODEL TRAINING METHOD, IMAGE EDITING METHOD, APPARATUS, DEVICE, MEDIUM, AND PRODUCT

(71) Applicants: Beijing Zitiao Network Technology Co., Ltd., Beijing (CN); Lemon Inc., Grand Cayman (KY)

(72) Inventors: Xin GU, Beijing (CN); Sijie ZHU, Los Angeles, CA (US); Fan CHEN, Los Angeles, CA (US); Longyin WEN, Los Angeles, CA (US)

(21) Appl. No.: 19/314,144

(22) Filed: Aug. 29, 2025

(30) Foreign Application Priority Data
Sep. 27, 2024 (CN) 202411366464.4

(51) Int. Cl. G06N 3/08; G06N 3/04; G06T 11/60

(52) U.S. Cl. CPC G06N 3/08; G06N 3/04; G06T 11/60

(57) ABSTRACT

The present application discloses a model training method, an image editing method, an apparatus, a device, a medium, and a product. The method includes: first acquiring an original image, an editing description text corresponding to the original image, an edited image corresponding to the original image with respect to the editing description text, and evaluation information of the edited image, enabling the evaluation information to describe the state of the edited image in at least one evaluation item. Then the original image, the editing description text and the evaluation information by using an image editing model are processed to obtain an image editing result corresponding to the original image. According to the difference between the image editing result and the edited image, the image editing model is updated.

### CROSS-REFERENCE TO RELATED APPLICATION(S)

This application claims priority to Chinese Application No. 202411366464.4 filed in September. 27, 2024, the disclosure of which is incorporated herein by reference in its entity.

### FIELD

The present application relates to the technical field of image processing, and more particularly to a model training method, an image editing method, an apparatus, a device, a medium, and a product.

### BACKGROUND

For some scenarios, such as retouching scenarios or instruction-based image editing scenarios, there are following requirements: editing an existing image according to the user's needs, such as adjusting the color of the hat in the image to blue, etc., to obtain the edited image.

However, how to realize the above editing processing has become an urgent technical problem to be solved.

### SUMMARY

The present application provides a model training method, an image editing method, an apparatus, a device, a medium, and a product, which are beneficial to improving an image editing effect.

In order to achieve the above object, the technical solutions provided by the present application are as follows:

The present application provides a model training method. The method includes: acquiring an original image, an editing description text corresponding to the original image, an edited image corresponding to the original image with respect to the editing description text, and evaluation information of the edited image, wherein the evaluation information is configured to describe a state of the edited image with respect to at least one evaluation item; processing the original image, the editing description text and the evaluation information by using an image editing model to obtain an image editing result corresponding to the original image; updating the image editing model according to a difference between the image editing result and the edited image.

In a possible embodiment, the at least one evaluation item comprises one or more of a text following evaluation item, an image preserving evaluation item, and an image quality evaluation item; the text following evaluation item is configured to describe a matching state presented between the edited image and the edit description text with respect to first content, the first content is determined in accordance with at least one edit instruction described by the edit description text; the image preserving evaluation item is configured to describe a matching state between the edited image and the original image with respect to second content, the second content is determined based on content in the original image other than the first content; the image quality evaluation term is configured to describe a quality change of the edited image relative to the original image.

In a possible embodiment, the evaluation information comprises a score of each of the evaluation items, and/or the evaluation information comprises a defect description text of some or all of the evaluation items; for one of the evaluation items, the score of the evaluation item is configured to characterize a level achieved by the edited image with respect to the one evaluation item, and the defect description text of the one evaluation item is configured to describe the defect of the edited image with respect to the evaluation item.

In a possible embodiment, the at least one evaluation item comprises one or more of a text following evaluation item, an image preserving evaluation item, and an image quality evaluation item; a score of the text following evaluation item is configured to describe a similarity degree between a change in content of the edited image relative to the original image and a change in content described by the edited description text; a score of the image preserving evaluation item is configured to describe a similarity degree between content retained by the edited image relative to the original image and content in the original image other than the edited content specified by the editing description text; A score of the image quality evaluation item is configured to describe a quality change of the edited image relative to the original image; a defect description text of the text following evaluation item is configured to describe at least one following error in the edited image relative to the edited description text; a defect description text of the image preserving evaluation item is configured to describe at least one preserving error of the edited image relative to the original image; a defect description text of the image quality evaluation item is configured to describe at least one quality defect of the edited image relative to the original image.

In a possible embodiment, the evaluation information is introduced as condition information into a de-noising network in the image editing model.

In a possible embodiment, for one of the cross-attention layers in the de-noising network, input data of a data fusion layer corresponding to the one cross-attention layer is determined based on the evaluation information and output data of the one cross-attention layer, and the input data of the one cross-attention layer includes an encoding result of the edit description text.

In a possible embodiment, the input data of the data fusion layer is determined based on a feature vector of the evaluation information; the evaluation information includes at least one type of data, and a feature vector of the evaluation information is determined according to a vectorization result of each type of data and a vectorization result of each type.

In a possible embodiment, the data fusion layer is configured to perform residual error calculation or sum value calculation based on a mapping result of the output data of the cross-attention layer and the feature vector of the evaluation information in a first feature space, and the first feature space is a feature space to which the output data of the cross-attention layer belongs.

In a possible embodiment, input data of a de-noising network in the image editing model comprises first data and second data, the first data is input to the de-noising network as condition information, the input data of a first network layer in the de-noising network comprises the second data, the first data is different from the second data; the second data is determined based on the original image and the evaluation information.

In a possible embodiment, determining the process of the second data includes: performing concatenating processing on an image feature of the original image and noise addition result of an image feature of the edited image to obtain concatenating result; performing convolution processing on the concatenating result to obtain a convolution result; performing at least one cross-attention processing according to a mapping result between the convolution result and the feature vector of the evaluation information in a second feature space to obtain the second data, and the second feature space is a feature space to which the convolution result belongs.

In a possible embodiment, the image editing model includes a first module, a second module, a third module, a linear layer corresponding to the third module, a de-noising network, a linear layer corresponding to the de-noising network, and a decoding module; the first module is configured to obtain a concatenating result between an image feature of the original image and a noise addition result of an image feature of the edited image; the second module is configured to acquire a feature vector of the evaluation information; the linear layer corresponding to the third module and the linear layer corresponding to the de-noising network are used for processing the feature vector of the evaluation information; the third module is configured to perform at least one cross-attention processing according to the concatenating result and the output data of the linear layer corresponding to the third module; the de-noising network is configured to perform de-noising processing according to the output data of the third module, the encoding result of the editing description text, and the output data of the linear layer corresponding to the de-noising network; the decoding module is used for performing decoding processing on the output data of the de-noising network to obtain the image editing result.

In a possible embodiment, updating the image editing model includes updating a part of modules in the image editing model, and the part of modules include some or all network layers in the second module, the third module, a linear layer corresponding to the third module, the de-noising network, and a linear layer corresponding to the de-noising network.

The present application provides an image editing method, wherein the method includes: acquiring a target image, editing description text corresponding to the target image, and preset constraint information; and processing the target image, the editing description text, and the preset constraint information by using an image editing model to obtain an image editing result corresponding to the target image, the preset constraint information is configured to describe a state of the image editing result with respect to at least one evaluation item, and the image editing model is determined by using a model training method provided by the present application.

The present application provides a model training apparatus, including: a first acquiring unit configured to acquire an original image, an editing description text corresponding to the original image, an edited image corresponding to the original image with respect to the editing description text, and evaluation information of the edited image, wherein the evaluation information is configured to describe a state of the edited image with respect to at least one evaluation item; a first processing unit configured to process the original image, the editing description text, and the evaluation information by using an image editing model to obtain an image editing result corresponding to the original image; a model updating unit configured to update the image editing model according to a difference between the image editing result and the edited image.

The present application provides an image editing apparatus, including: a second acquiring unit configured to acquire a target image, an editing description text corresponding to the target image, and preset constraint information; a second processing unit configured to process the target image, the editing description text, and the preset constraint information by using an image editing model to obtain an image editing result corresponding to the target image, the preset constraint information is configured to describe a state of the image editing result with respect to at least one evaluation item, and the image editing model is determined by using a model training method provided in the present application.

The present application provides an electronic device comprising: a processor and a memory; the memory for storing instructions or a computer program; the processor is configured to execute the instructions or the computer program in the memory to cause the electronic device to execute the model training method or the image editing method provided in the present application.

The present application provides a computer-readable medium in which instructions or computer programs are stored, and when the instructions or computer programs are run on a device, the device performs a model training method or an image editing method provided in the present application.

The present application provides a computer program product comprising a computer program carried on a non-transitory computer-readable medium, the computer program including program code for executing a model training method or an image editing method provided herein.

Compared with the related art, the present application has at least the following advantages:

In the technical solution provided by the present application, an original image, an editing description text corresponding to the original image, an edited image corresponding to the original image with respect to the editing description text, and evaluation information of the edited image are first obtained, to allow the evaluation information to describe a state of the edited image in at least one evaluation item, so that the evaluation information can indicate a shortcoming of the edited image, and the evaluation information can indicate a level required for image editing processing of the original image; then the original image, the editing description text and the evaluation information is processed by using the image editing model to obtain an image editing result corresponding to the original image; then, according to the difference between the image editing result and the edited image, the image editing model is updated, so that the updated model has better image editing performance, so that the image editing processing based on the model can achieve better effect.

The image editing model performs image editing processing according to the evaluation information, so that the image editing model can accurately obtain the following information with the assistance of the evaluation information: what level the image editing processing needs to achieve for the original image, and the information about the shortcomings of the image obtained by the image editing processing, etc., so that the image editing model can learn how to perform image editing processing with respect to the constraints described by the evaluation information, and then the image editing model can learn how to flexibly control the state of the output image in at least one evaluation item, so that the interference caused by the defect of the edited image in the training data can be effectively overcome, and the performance of the image editing model can be improved.

### BRIEF DESCRIPTION OF THE DRAWINGS

In order to more clearly explain the technical solutions in the embodiments of the present application or related technologies, the drawings that need to be used in the description of the embodiments or related technologies will be briefly introduced below, and it is obvious that the drawings in the following description are only some embodiments described in the present application, and other drawings can be obtained from these drawings without making creative labor for those skilled in the art.

FIG. 1 is a flowchart of a model training method according to an embodiment of the present application.

FIG. 2 is a schematic structural diagram of a diffusion model provided by an embodiment of the present application.

FIG. 3 is a schematic structural diagram of another diffusion model provided by an embodiment of the present application.

FIG. 4 is a schematic structural diagram of another diffusion model provided by an embodiment of the present application.

FIG. 5 is a schematic structural diagram of another diffusion model provided by an embodiment of the present application.

FIG. 6 is a flowchart of an image editing method according to an embodiment of the present application.

FIG. 7 is a schematic structural diagram of a model training device according to an embodiment of the present application.

FIG. 8 is a schematic structural diagram of an image editing apparatus according to an embodiment of the present application.

FIG. 9 is a schematic structural diagram of an electronic device according to an embodiment of the present application.

### DETAILED DESCRIPTION OF EMBODIMENTS

Through research, it is found that some implementation schemes of image editing processing are: first collect and construct some training data, so that the training data includes the triple {original image, editing instructions text, edited image}; then the training data is configured to train a certain machine learning model to obtain a model with image editing function, so that the model can subsequently perform image editing processing according to the original image and the editing instruction text.

Through research, it is also found that the implementation scheme shown in the above paragraph has the following defects: because the edited image is generated in some way, the edited image may have certain defects, such as poor quality and unnatural defects, which makes the model trained by using the edited image as truth information have relatively poor performance, and then affects the editing processing effect.

Based on the above two studies, in order to better improve the editing processing effect, the present application provides a model training method, the mothed comprises acquiring an original image, an editing description text corresponding to the original image, an edited image corresponding to the original image with respect to the editing description text, and evaluation information of the edited image, to allow the evaluation information to describe a state of the edited image in at least one evaluation item, so that the evaluation information can indicate a shortcoming of the edited image, and the evaluation information can indicate a level required for image editing processing of the original image; then the original image, the editing description text and the evaluation information is processed by using the image editing model to obtain an image editing result corresponding to the original image; then, according to the difference between the image editing result and the edited image, the image editing model is updated, so that the updated model has better image editing performance, so that the image editing processing based on the model can achieve better effect.

The image editing model performs image editing processing according to the evaluation information, so that the image editing model can accurately obtain the following information with the assistance of the evaluation information: what level the image editing processing needs to achieve for the original image, and the information about the shortcomings of the image obtained by the image editing processing, etc., so that the image editing model can learn how to perform image editing processing with respect to the constraints described by the evaluation information, and then the image editing model can learn how to flexibly control the state of the output image in at least one evaluation item, so that the interference caused by the defect of the edited image in the training data can be effectively overcome, and the performance of the image editing model can be improved.

Note that the present application does not limit the execution body of the model training method provided in the embodiment of the present application, and for example, the model training method provided in the embodiment of the present application may be applied to a terminal device or a server. As another example, the model training method provided by the embodiment of the present application may also be implemented by a data interaction process between the terminal device and the server. The terminal device may be a smartphone, a computer, a personal digital assistant (PDA), a tablet computer, or the like. The server can be a standalone server, a cluster server, or a cloud server.

In order to enable those skilled in the art to better understand the solutions of the present application, the technical solutions in the embodiments of the present application will be clearly and completely described below with reference to the accompanying drawings in the embodiments of the present application, and it is obvious that the described embodiments are only a part of the embodiments of the present application, but not all of the embodiments. Based on the embodiments in the present application, all other embodiments obtained by those skilled in the art without creative work fall within the scope of protection of the present application.

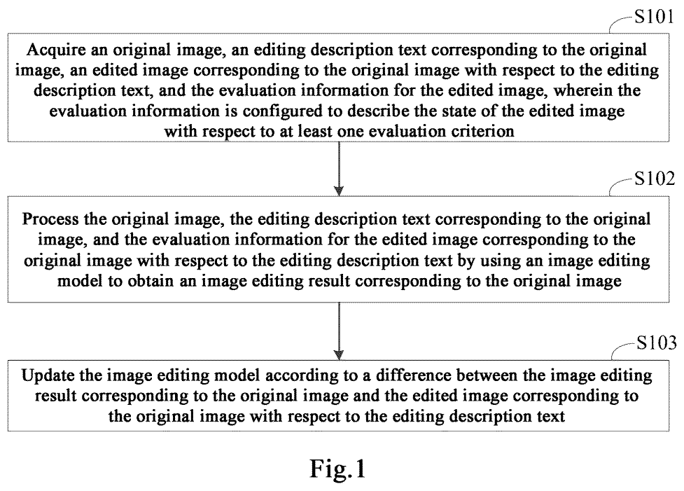

In order to better understand the technical solution provided in the present application, the model training method provided in the present application will be described below in conjunction with some drawings. As shown in FIG. 1, the model training method according to the embodiment of the present application includes S101-S103 below. FIG. 1 is a flowchart of a model training method according to an embodiment of the present application.

S101: an original image, an editing description text corresponding to the original image, an edited image corresponding to the original image with respect to the editing description text, and evaluation information of the edited image are acquired, wherein the evaluation information is configured to describe a state of the edited image with respect to at least one evaluation item.

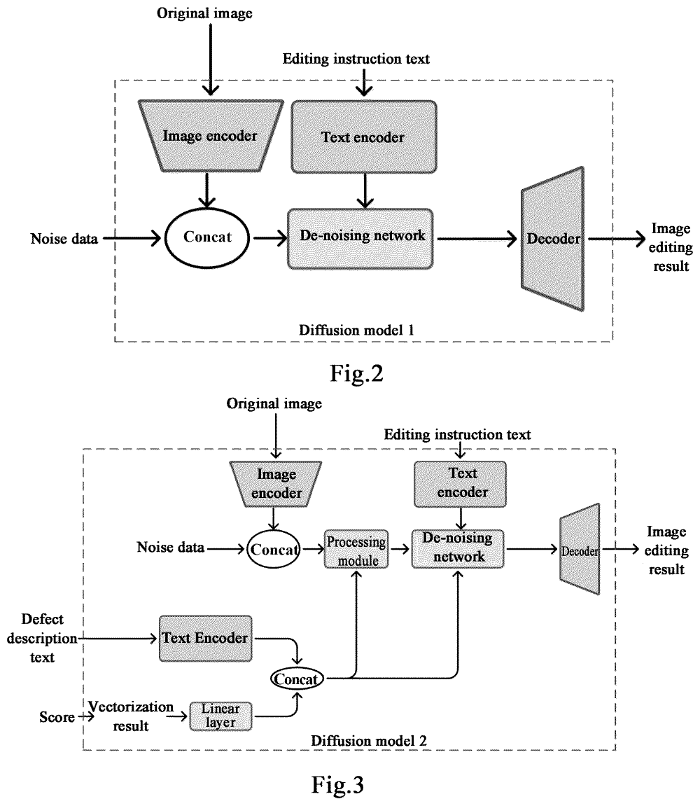

Here, the original image refers to an image that exists in the training data and needs to be subjected to image editing processing, such as the original image shown in any one of FIGS. 2 to 5, so that the original image is configured to provide other contents other than the contents that need to be edited for the image editing processing, so that the result obtained by the image editing processing is as consistent as possible with the original image in other contents.

It should be noted that the present application does not limit the embodiment of maintaining consistency, for example, in some scenarios, such as scenarios with relatively high accuracy requirements, maintaining consistency refers to being completely identical, so that the actual meaning of the statement “maintaining consistency with information 1 and information 2” is that information 1 and information 2 are completely identical. For another example, in some scenarios, such as scenarios with relatively low accuracy requirements, the consistency means that the similarity degree is very high, so that the actual meaning of the sentence “information 1 and information 2 are consistent” is that the similarity between information 1 and information 2 is higher than the preset similarity threshold.

It should also be noted that, for the training data involved in the model training process provided in the present application, the training data is implemented in a four-tuple group of {original image, editing description text corresponding to the original image, edited image corresponding to the original image with respect to the editing description text, and evaluation information of the edited image}, so that the training data can not only represent the image truth value required for reference for image editing processing of the original image, but also represent the level required for image editing processing of the original image, thus effectively overcoming the adverse effects caused by defects in the image truth value, and thus facilitating improvement of model performance.

Further, the present application does not limit the characteristics of all the training data involved in the model training process provided in the present application. For example, it can satisfy at least the following constraints: all the training data involved in the model training process traverses various situations (such as various states with respect to various evaluation items, etc.) as much as possible, so as to ensure that the model obtained based on the training data can learn how to flexibly control the state of its output image in at least one evaluation item as much as possible, which is beneficial to improving image editing performance.

In addition, the present application does not limit the acquiring process of the original image, and for example, it may be implemented by any existing or future acquiring method.

The editing description text corresponding to the original image refers to text of the training data and which needs to be referred to when image editing processing is performed on the original image, such as the editing instruction text shown in any one of FIGS. 2 to 5, so that the text can describe what kind of editing is performed on the original image.

It can be seen that, in one possible embodiment, the editing description text corresponding to the original image may be configured to describe at least one editing instruction for the original image. As an example, when the edit description text includes the content of “adjusting the color of the hat to blue”, the edit description text may be used at least to describe a target instruction, and the target instruction is configured to indicate an edit requirement of “adjusting the color of the hat to blue”.

In addition, the present application does not limit the process of obtaining the editing description text corresponding to the original image, and for example, it can be implemented by any existing or future method of obtaining text, such as a method of manually providing text by a user or a method of automatically generating text by a certain machine learning model.

The edited image corresponding to the original image with respect to the editing description text refers to an image of the training data and used as truth information, so that the edited image can represent the actual result of image editing processing on the original image according to the editing description text, so that the edited image can guide the image editing result of the original image with respect to the editing description text, such as the image editing result shown in any one of FIGS. 2 to 5, during the model training process, and further the edited image can guide the model to learn how to perform image editing processing.

In addition, the present application does not limit the process of acquiring the edited image shown in the above paragraph, and for example, it may be implemented by any existing or future method of acquiring the edited image. As another example, it can be implemented by manual labeling. For another example, the process of obtaining the edited image may specifically be that the machine learning model having the image generation function performs image generation processing based on the original image and the editing description text corresponding to the original image to obtain the edited image. It is to be noted that the present application does not limit the embodiment of the machine learning model.

In addition, for the edited image corresponding to the original image with respect to the editing description text, the evaluation information of the edited image is obtained by performing evaluation processing on the edited image, so that the evaluation information is configured to describe the state of the edited image with respect to at least one evaluation item, so that the evaluation information can indicate the advantages and disadvantages of the edited image, and then the evaluation information can indicate the deficiencies of the edited image, such as poor quality, so that the image editing processing of the original image can be subsequently restricted according to the evaluation information.

Further, the present application does not limit the implementation mode of at least one of the above evaluation items, for example, it may be implemented by using any existing or future index item capable of characterizing the state of the image, such as index items such as quality, naturalness, and light distribution.

Through research, it is found that the expected goals of the image editing process for the original image at least include: the result obtained by the image editing process meet the editing requirements of the content described by the editing description text corresponding to the original image as much as possible, and the result obtained by the image editing process are as consistent as possible with the original image in other contents except the contents to be edited. Therefore, in order to better improve the image editing effect, these goals can be used as evaluation items to measure the quality of an image.

Based on the above study, in order to better improve the effect, the above at least one evaluation item may include one or more of a text following evaluation item, an image preserving evaluation item, and an image quality evaluation item, so that the quality level of an image can be better measured by means of these evaluation items in the future. For ease of understanding, these three evaluation items are introduced below.

For the text following evaluation item, the text following evaluation item is configured to evaluate whether the edited image can meet the editing requirements of the content described by the editing description text, thereby enabling the text following evaluation item to indicate whether the edited image can accurately and comprehensively cover the editing instructions described by the editing description text, thereby enabling the text following evaluation item to indicate the matching state between the edited image and the editing description text, thereby enabling the text following evaluation item to describe the matching state presented between the edited image and the editing description text with respect to the first content.

Here, the first content refers to the content that needs to be paid attention to when evaluating the text following the evaluation item; and the first content may be determined in accordance with at least one editing instruction described by the editing description text, such that the first content may represent the content referred to by the editing instructions, such as the content of “hat color”, such that the first content may include the editing content specified by the editing description text, thereby enabling the first content to represent the content that needs to be edited.

For the image preserving evaluation item, the image preserving evaluation item is configured to evaluate whether the edited image can satisfy the content preserving requirement involved in the original image, so that the image preserving evaluation item can indicate whether the edited image can accurately and comprehensively retain other contents in the original image except the edited content specified by the editing description text corresponding to the original image, and then the image preserving evaluation item can indicate the matching state between the edited image and the original image, enabling the image preserving evaluation item is configured to describe the matching state presented between the edited image and the original image with respect to the second content.

Here, the second content refers to a content that needs to be paid attention to when evaluating the image preserving evaluation item; and the second content is determined according to other content in the original image other than the first content, so that the first content can represent content related to the editing description text of the original image but not corresponding to the original image, so that the second content can include a difference set between the set of content described by the original image and the set of content described by the editing description text, so that the second content can represent content that does not need to be subjected to editing processing, that is, content that needs to be subjected to preserving processing.

For an image quality evaluation item, the image quality evaluation item is configured to evaluate the image quality of the edited image; moreover, the present application does not limit the embodiment of the evaluation item of the image quality evaluation item, and for example, in some scenarios, the image quality evaluation item of the edited image can be implemented by any method capable of evaluating the quality of the image, so that the evaluation result of the image quality evaluation item of the edited image can indicate the quality level of the edited image itself.

It is found that in some scenarios, the quality level of the edited image generated based on the original image is not high because the quality level of the original image itself is not high. As an example, if there is a hand deformity problem such as multi-finger in the original image, the edited image obtained by performing image editing processing on the original image will theoretically still have this problem based on the content preserving principle, thus affecting the quality of the edited image.

Based on the above research, it can be known that the self-quality of the original image will affect the self-quality of the edited image, so in order to better overcome the interference caused by the influence, the present application provides a possible implementation mode of the image quality evaluation item, in which the image quality evaluation item can be configured to evaluate the relative gap between the edited image and the original image in quality, so that the image quality evaluation item can be configured to describe the quality change of the edited image relative to the original image, and then the image quality evaluation item can more accurately represent the level achieved by the image editing process in quality.

In addition, the present application does not limit the embodiment of the above-described evaluation information, for example, when the evaluation information is configured to describe the state of the above-described edited image with respect to at least one evaluation item, the evaluation information may include the score of each evaluation item, so that the evaluation information can better represent the level reached by the edited image with respect to each evaluation item. For any evaluation item, the score of the evaluation item is configured to characterize a level of the edited image with respect to the evaluation item.

For another example, when the above evaluation information is configured to describe the state of the above edited image with respect to at least one evaluation item, the evaluation information may include defect description text of some or all of the evaluation items, so that the evaluation information can better represent defects of the edited image with respect to these evaluation items, such as content 1 is not accurately followed, content 2 is not accurately preserved, and hand deformity. For any evaluation item, the defect description text of the evaluation item is configured to describe the defect of the edited image with respect to the evaluation item.

Further, in order to better improve the effect, when the above evaluation information is configured to describe the state of the above edited image with respect to at least one evaluation item, the evaluation information may include a score of each evaluation item and a defect description text of some or all of the evaluation items.

Based on the related content of the above evaluation information, in a possible embodiment, the evaluation information may include a score of the text following evaluation item, a score of the image preserving evaluation item, a score of the image quality evaluation item, a defect description text of the text following evaluation item, a defect description text of the image preserving evaluation item, and a part or all of the defect description text of the image quality evaluation item.

For the above “score of the text following evaluation item”, the “score of the text following evaluation item” is configured to describe the similarity degree between the content change of the edited image with respect to the original image and the content change described by the edited description text, so that the “score of the text following evaluation item” can indicate to some extent whether the edited image can accurately and comprehensively meet the content editing requirements described by the edited description text, and thus can indicate the level of image editing processing in terms of following. The “content change of the edited image with respect to the original image” is configured to describe a difference existing between the edited image and the original image. The “content change described by the editing description text” refers to the change described by the editing description text.

For the above “score of the image preserving evaluation item”, the “score of the image preserving evaluation item” is configured to describe the similarity degree between the content retained by the edited image relative to the original image and other content in the original image except the edited content specified by the editing description text, so that the “score of the image preserving evaluation item” can indicate the degree of content preserving of the edited image relative to the original image, thereby enabling the “score of the image preserving evaluation item” to some extent whether the edited image can accurately and comprehensively retain the content unedited in the original image. The “retained content of the edited image with respect to the original image” is configured to describe content in which there is no difference between the edited image and the original image. The “editing content specified by the editing description text” refers to content described by the editing description text that requires editing processing.

For the above “score of the image quality evaluation item”, the “score of the image quality evaluation item” is configured to describe the quality change (such as quality fluctuation, etc.) of the edited image with respect to the original image, so that the “score of the image quality evaluation item” can indicate the gap between the own quality of the edited image and the own quality of the original image, so that the “score of the image quality evaluation item” can indicate the level achieved by the image editing process in terms of quality.

For the above “text following the defect description text of the evaluation item”, the “text following the defect description text of the evaluation item” is configured to describe at least one following error in the edited image with respect to the edit description text, such as the error of “wrongly changing the hat color to red”, so that the “text following the defect description text of the evaluation item” can represent the content in the edited image that does not reach the editing target described by the edit description text, such as the content in which the editing error occurs, the content in which the editing error is forgotten, etc.

For the above “defect description text of the image preserving evaluation item”, the “defect description text of the image preserving evaluation item” is configured to describe at least one preserving error of the edited image with respect to the original image, such as the error of “skin color is not retained”, so that the “defect description text of the image preserving evaluation item” can represent an additional change in the content change of the edited image with respect to the original image that does not belong to the content change described by the editing description text, thereby enabling the “defect description text of the image preserving evaluation item” to represent the content present in the edited image with respect to the original image.

For the above “defect description text of the image quality evaluation item”, the “defect description text of the image quality evaluation item” is configured to describe at least one quality defect of the edited image with respect to the original image, such as a defect such as unnatural light transition, so that the “defect description text of the image quality evaluation item” can represent an influencing factor of the edited image that causes the quality of the edited image to be inferior to the quality of the original image, so that the “defect description text of the image quality evaluation item” can represent a defect in the quality of the image editing process.

In addition, the present application does not limit the method of obtaining the above evaluation information, for example, any machine learning model having image evaluation performance may be adopted, so that the machine learning model can evaluate the edited image corresponding to the original image with respect to the editing description text according to the original image and the editing description text corresponding to the original image, and obtain and output evaluation information of the edited image, so that the evaluation information can indicate the state of the edited image with respect to at least one evaluation item, such as score and/or defect description text.

Based on the relevant content of S101 above, for some scenarios, after acquiring the original image, the editing description text corresponding to the original image, and the edited image corresponding to the original image with respect to the editing description text, the edited image can be evaluated according to the original image and the editing instruction text to obtain evaluation information of the edited image, so that the evaluation information can represent the advantages and disadvantages of the edited image, so that the evaluation information can supplement some characteristics to the edited image, such that the training data consisting of {original image, the editing description text, the edited image, and the evaluation information} for model training can be subsequently utilized, to achieve the comprehensive influence of the edited image and its evaluation information on the training process, and to assist the model in identifying and understanding the deficiencies in the edited images within this training data, thereby enabling the model to have better performance.

S102: the original image, the editing description text corresponding to the original image, and the evaluation information of the edited image corresponding to the original image with respect to the editing description text are processed by the image editing model to obtain an image editing result corresponding to the original image.

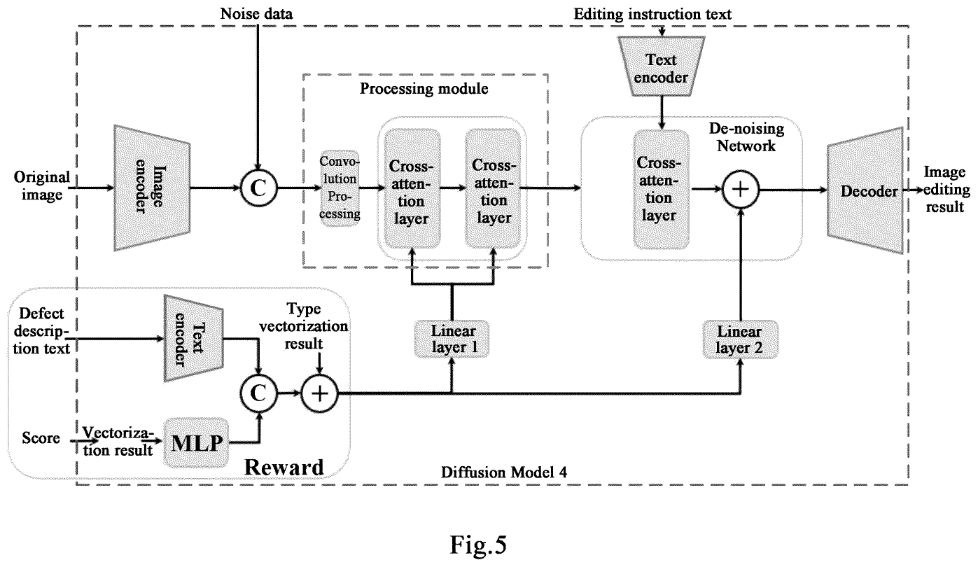

The image editing model is configured to perform image editing processing, such as the image editing processing shown in FIG. 3 or FIG. 5, according to the input data of the image editing model.

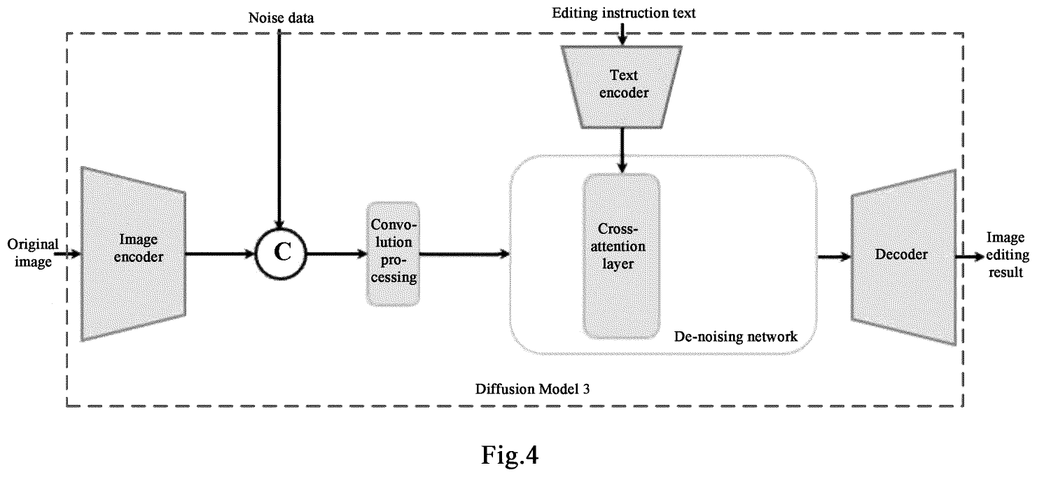

In addition, the present application does not limit the embodiment of the above image editing model, and for example, the image editing model may be constructed based on any diffusion model, such as Instructpix2pix, the diffusion model 1 shown in FIG. 2, or the diffusion model 3 shown in FIG. 4, so that the image editing model includes all network layers in the diffusion model, so that the image editing model has an image generation function, so that the image editing model can subsequently realize image editing processing by the image generation method.

It can be seen that in one possible embodiment, the image editing model described above may include at least a de-noising network, such as the de-noising network shown in FIG. 3 or FIG. 5, so that image generation processing can be implemented subsequently by means of the de-noising network.

In addition, in order to better improve the image editing effect, the above image editing model may satisfy at least the following constraint: the above evaluation information is introduced as condition information into the de-noising network in the image editing model, so that the de-noising network can perform de-noising processing with respect to the constraint of the condition of the evaluation information.

It can be seen that in one possible embodiment, the working principle of the above image editing model may at least include: introducing the editing description text corresponding to the original image and the above evaluation information as condition information into the de-noising network of the image editing model, so that the image editing model can perform image editing processing on the original image with respect to the constraints of the two conditions, so that the image output by the image editing model satisfies the two conditions as much as possible.

Furthermore, the present application does not limit the introduction mode of the condition information of editing the description text above, for example, it can be implemented by any existing or future mode of introducing the condition of the text into the de-noising network, such as a cross-attention mode.

It can be seen that, in one possible embodiment, the above image editing model may satisfy at least the following constraints: the condition information of editing the description text above is introduced into the de-noising network in the image editing model through a cross-attention manner, so that the de-noising network can perform de-noising processing with respect to the constraint of the condition of editing the description text.

Furthermore, the present application does not limit the method of introducing the conditional information of the above evaluation information, for example, it may be implemented by any existing or future method capable of introducing the conditional information into the de-noising network, such as a cross-attention method.

It is found that in order to improve the influence of the above evaluation information on image editing as much as possible, direct data fusion can be adopted to introduce the evaluation information, which is the condition information, into the image editing model de-noising network.

It can be seen that in one possible embodiment, the above image editing model may satisfy at least the following constraints: the image editing model includes a de-noising network, and for any cross-attention layer in the de-noising network, input data of a data fusion layer corresponding to the cross-attention layer is determined based on the evaluation information and output data of the cross-attention layer, and the input data of the cross-attention layer includes an encoding result of the above editing description text.

For any cross-attention layer in the de-noising network, the cross-attention layer is used for implementing the process of introducing the condition information for the above editing description text, and the cross-attention layer can be specifically used for: performing cross-attention processing on the encoding result of the editing description text and the output data of the previous network layer corresponding to the cross-attention layer. The previous network layer refers to a network layer of the de-noising network, whose arrangement position is adjacent to the cross-attention layer, and whose arrangement position is ahead of the arrangement position of the cross-attention layer. The encoding result of the editing description text is obtained by performing text encoding processing on the editing description text, so that the encoding result can better represent the information carried by the editing description text.

It should be noted that the present application does not limit the embodiment of the text encoding process, and for example, it may be implemented by any existing editor having a text encoding function that appears in the future, such as a text encoder in a Contrastive Language-Image Pre-training (CLIP) model.

In addition, for any cross-attention layer in the de-noising network, the data fusion layer corresponding to the cross-attention layer refers to a network layer of the de-noising network, which is arranged adjacent to the cross-attention layer, and which is arranged behind the arrangement position of the cross-attention layer, such as a residual layer or a network layer having a mark “+” as shown in the de-noising network in FIG. 5, and the data fusion layer can be specifically configured to fuse the output data of the cross-attention layer with the above evaluation information, so that the data fusion layer can realize the introduction process of conditional information for the evaluation information.

In addition, the present application does not limit the embodiment of the above-described data fusion layer, for example, for any cross-attention layer in the de-noising network, the data fusion layer corresponding to the cross-attention layer may satisfy at least the following constraint: the input data of the data fusion layer is determined according to the feature vector of the above-described evaluation information.

The feature vector of the above evaluation information is configured to better represent what is described by the evaluation information. Moreover, the present application does not limit the method of determining the feature vector.

Further, in order to better improve the effect, when the above evaluation information includes at least one type of data, the feature vector of the evaluation information is determined according to the vectorization result of each type of data and the vectorization result of each type, so that the feature vector can better represent the content described by the evaluation information. In order to facilitate understanding, the following description will be made with reference to examples.

As an example, when the above evaluation information includes a score of the text following evaluation item, a score of the image preserving evaluation item, a score of the image quality evaluation item, a defect description text of the text following evaluation item, a defect description text of the image preserving evaluation item, and a defect description text of the image quality evaluation item, the determination process of the feature vector of the evaluation information may include steps 11 to 15 below.

Step 11: numerical vectorization processing is performed on the score of the text following evaluation item, the score of the image preserving evaluation item and the score of the image quality evaluation item respectively to obtain a vectorization result of the following score, a vectorization result of the preserving score and a vectorization result of the quality score, so that the vectorization result of the following score can better represent the score of the text following evaluation item, the vectorization result of the preserving score can better represent the score of the image preserving evaluation item, and the vectorization result of the quality score can better represent the score of the image quality evaluation item.

It should be noted that the present application does not limit the embodiment of the numerical vectorization process, and for example, it may be implemented by any existing or future method capable of mapping numerical values into numerical embedding, such as Position Encoding.

Step 12: text vectorization processing is performed on the defect description text of the text following evaluation item, the defect description text of the image preserving evaluation item, and the defect description text of the image quality evaluation item respectively to obtain a text vectorization result of the following defect, a text vectorization result of the preserving defect, and a text vectorization result of the quality defect, so that the text vectorization result of the following defect can better represent the defect described by the defect description text of the image quality evaluation item.

It should be noted that the present application does not limit the embodiment of the text vectorization process, and for example, it may be implemented by any existing or future method capable of mapping text into text embedding, such as any text encoding process.

It should also be noted that the present application does not limit the execution time of the above step 12, and only needs to ensure that the execution time of the above step 12 is earlier than the execution time of the following step 14.

Step 13: the vectorized result of the following score, the vectorized result of the preserving score, and the vectorized result of the quality score are mapped to a target feature space to obtain the mapping result corresponding to the following score, the mapping result corresponding to the preserving score, and the mapping result corresponding to the quality score to the target feature space, so as to avoid defects caused by inconsistency in the feature space. Among them, the target feature space refers to the feature space in which the above text vectorization result is located.

It should be noted that the present application does not limit the embodiment of step 13 above, for example, it may be implemented by any method capable of mapping data in one feature space to another feature space, such as a Linear layer (Linear) or a multi-layer perceptron (MLP).

Step 14: a text vectorization result of the following defect, a text vectorization result of preserving defect, a text vectorization result of the quality defect, a mapping result corresponding to the following score, a mapping result corresponding to the preserving score, and a mapping result corresponding to the quality score are concatenated to obtain a first concatenating result.

It should be noted that the present application does not limit the embodiment of step 14 above, for example, it may be implemented by any existing or future method having a concatenating function, such as a concat network layer.

Step 15: residual error calculation or sum value calculation is performed on the data type vectorization result of the above evaluation information and the above first concatenating result to obtain a feature vector of the above evaluation information. The data type vectorization result includes various types of vectorization result related to the evaluation information, so that the type vectorization result can describe a type to which different parts in the first concatenating result belong, such as a numerical value or a text type, and so that the type vectorization result is configured to distinguish different parts in the first concatenating result.

Based on the relevant contents of steps 11 to 15, when the evaluation information includes numerical data (e.g., a score of the text following evaluation item, a score of the image preserving evaluation item, and a score of the image quality evaluation item) and text data (e.g., a defect description text of the text following evaluation item, a defect description text of the image preserving evaluation item, and a defect description text of the image quality evaluation item), the numerical data may be vectorized first to obtain a vectorized result of the numerical data, and the text data may be vectorized (e.g., a text encoding process. Then the data vectorization result of the numerical type is mapped to a feature space to which the data vectorization result of the text type belongs, and obtaining a data mapping result corresponding to the numerical type, so that the data mapping result and the data vectorization result of the text type belong to the same feature space; then, concatenating the data vectorization result of the text type and the data mapping result corresponding to the numerical type to obtain the concatenating result. Finally, the concatenating result and the data type vectorization result of the evaluation information are subjected to residual error calculation or sum value calculation to obtain a feature vector of the evaluation information, so that the feature vector can better characterize the content described by the evaluation information, and then make the image editing processing based on the evaluation information better.

In addition, in order to better improve the influence of the evaluation information, the present application also provides an implementation mode of the above data fusion layer, in which, for any cross-attention layer in the de-noising network, the data fusion layer corresponding to the cross-attention layer can satisfy at least the following constraints: the data fusion layer is configured to perform residual error calculation or sum value calculation according to the mapping result of the output data of the cross-attention layer and the feature vector of the evaluation information in a first feature space, and the first feature space is the feature space to which the output data of the cross-attention layer belongs, so that the content described by the evaluation information can be more effectively utilized. The mapping result is configured to represent a state of the evaluation information in the first feature space. Moreover, the present application does not limit the method of determining the mapping result, and for example, the mapping result can be obtained by processing the feature vector of the evaluation information by a linear layer, such as the linear layer 2 shown in FIG. 5.

Through research, it is found that the input data of the de-noising network includes two parts, one part is used as condition information, so that this part can only affect the processing process of some network layers in the de-noising network, but the other part includes noise information, so that the other part can be used as the processing object, so that the other part can affect the processing process of all network layers in the de-noising network.

Based on the above studies, the present application provides a possible embodiment of the above image editing model, in which the image editing model can satisfy at least the following constraints: input data of a de-noising network in the image editing model includes first data and second data, the first data is input to the de-noising network as condition information, and input data of a first network layer in the de-noising network includes the second data, the first data is different from the second data, the second data is determined from the original image and the above evaluation information.

The first data refers to a part of the input data of the de-noising network and used as condition information. Moreover, the present application does not limit the first data, for example, the first data can be determined according to the editing description text corresponding to the original image, so that the de-noising network can perform de-noising processing with respect to the constraint of the editing description text condition. For another example, in order to better improve the effect, the first data may be further determined according to the above evaluation information, so that the de-noising network can perform de-noising processing with respect to the constraints of two conditions of the editing description text and the evaluation information. It can be seen that, in one possible embodiment, the first data may include the encoding result of the above editing description text and the mapping result of the feature vector of the above evaluation information in the first feature space.

The second data refers to the portion of the input data of the de-noising network that is presented and configured to affect all network layers in the de-noising network. Furthermore, the second data is determined from the original image and the above evaluation information.

In addition, the present application does not limit the determination method of the above second data, for example, it may specifically include the following steps 21 to 23.

Step 21: concatenating processing is performed on an image feature of the original image and the noise addition result of an image feature of the edited image to obtain the concatenating result.

The image feature of the original image is obtained by performing image feature extraction processing on the original image, so that the image feature can represent information carried by the original image.

It should be noted that the present application does not limit the embodiment of the image feature extraction process, and for example, the image feature extraction process may be implemented by any existing or future image feature extraction method, such as a Variational auto (VAE) encoder.

The image feature of the edited image is obtained by performing image feature extraction processing on the edited image, so that the image feature can represent information carried by the edited image.

The noise addition result of the image feature of the edited image is obtained by adding noise to the image feature of the edited image. It should be noted that the present application does not limit the embodiment of the noise addition process, and for example, the noise addition method related to any existing or future diffusion model may be configured to implement the noise addition process.

Based on the relevant contents of step 21 above, for some scenes, after the original image and the edited image is acquired, the VAE encoder can first process the two images respectively to obtain the image feature of the original image and the image feature of the edited image. Then, noise processing is performed on the image feature of the edited image to obtain the noise addition result of the image feature of the edited image; then, the image feature of the original image is concatenated with the noise addition result to obtain the concatenating result.

Step 22: convolution processing is performed on the above concatenating result to reduce the number of channels of the concatenating result from 8 to 4 to obtain a convolution result.

Step 23: at least one cross-attention processing is performed according to the mapping result of the convolution result and the feature vector of the evaluation information in a second feature space to obtain second data, and the second feature space is a feature space to which the convolution result belongs. The mapping result is configured to represent a state of the evaluation information in the second feature space. Moreover, the present application does not limit the method of determining the mapping result. For example, the mapping result can be obtained by processing the feature vector of the evaluation information by a linear layer, such as the linear layer 1 shown in FIG. 5.

Based on the relevant contents of steps 21 to 23 above, for some scenarios, after the training data {original image, editing description text corresponding to the original image, edited image corresponding to the original image with respect to the editing description text, and evaluation information of the edited image} is obtained, the second data required to be input by the de-noising network in the image editing model can be determined according to the image feature of the original image, the noise addition result of the image feature of the edited image (noise data shown in FIG. 5), and the feature vector of the evaluation information, so that the de-noising network can subsequently perform de-noising processing on the second data.

In addition, in order to better improve the image editing effect, the above image editing model may include a first module, a second module, a third module, a linear layer corresponding to the third module, a de-noising network, a linear layer corresponding to the de-noising network, and a decoding module.

For the first module described above, the first module is configured to process a first part of the input data of the image editing model, such as data such as an original image, so that the first module can obtain a concatenating result between the image feature of the original image and the noise addition result of the image feature of the edited image. In addition, the present application does not limit the embodiment of the first module. For example, the first module may be configured to: first acquire the image feature of the original image and the noise addition result of the image feature of the edited image; then, concatenate the image feature of the original image and the noise-added result of the image feature of the edited image to obtain the concatenating result.

For the second module described above, such as the reward module shown in FIG. 5, the second module is used for processing a second part of the input data of the image editing model, such as data such as evaluation information. Moreover, the present application does not limit the embodiment of the second module. For example, the second module may be configured to perform a determination process of the feature vector of the evaluation information, such as the determination process shown in steps 11 to 15 above.

For the linear layer corresponding to the third module, such as the linear layer 1 shown in FIG. 5, the linear layer is configured to map the output data of the second module to another feature space (such as the second feature space or the feature space to which the output data of the first module belongs), so as to realize unification of the feature space. It should be noted that the present application does not limit the embodiment of the linear layer, and for example, the linear layer may be implemented using a fully connected layer.

As for the third module, the processing module shown in FIG. 5, the third module is configured to perform at least one cross-attention processing according to the output data of the first module (or the convolution processing result of the output data of the first module) and the output data of the linear layer corresponding to the third module, so that the image information and the evaluation information can be fused, so that the evaluation information can guide the de-noising process according to the influence mode of the noise addition result, so that the influence of the evaluation information can run through the whole de-noising process, and thus is beneficial to improve the de-noising performance.

For a linear layer corresponding to the de-noising network described above, such as the linear layer 2 shown in FIG. 5, the linear layer is configured to map the output data of the second module described above (such as the feature vector of evaluation information) to the feature space (such as the first feature space described above) to which the output data of the cross-attention layer in the de-noising network belongs, so as to realize unification of the feature space. It should be noted that the present application does not limit the embodiment of the linear layer, and for example, the linear layer may be implemented using a fully connected layer.

For the de-noising network described above, as shown in FIG. 5, the de-noising network is configured to perform de-noising processing according to the output data of the third module, the encoding result of the edited description text described above, and the output data of the linear layer corresponding to the de-noising network, so as to realize the de-noising processing on the output data of the third module with respect to the constraints of the edited description text and the evaluation information described above.

For the above decoding module, such as the decoder shown in FIG. 5, the decoding module is used for decoding the output data of the de-noising network to obtain the image editing result. It should be noted that the present application does not limit the embodiment of the decoding module, and for example, the decoding module may be implemented using a VAE decoder.

Based on the relevant content of S102 above, in some scenarios, after obtaining the training data of {original image, editing description text corresponding to the original image, edited image corresponding to the original image with respect to the editing description text, and evaluation information of the edited image}, the original image, the editing description text, and the evaluation information may be processed by using an image editing model, such as the diffusion model 2 shown in FIG. 3 or the diffusion model 4 shown in FIG. 5, to obtain an image editing result corresponding to the original image, so that the image editing result can represent the predicted state of the original image with respect to the editing description text.

S103: the image editing model is updated according to the difference between the image editing result corresponding to the original image and the edited image corresponding to the original image with respect to the editing description text.

It should be noted that the present application does not limit the above embodiment of S103, and for example, specifically, the model loss of the image editing model may be determined according to the difference between the image editing result corresponding to the original image and the edited image corresponding to the original image with respect to the editing description text, so that the model loss can represent the performance of the image editing model; then, according to the loss of the model, the image editing model is updated. Note that the present application does not limit the calculation method of the model loss.

In this mode, when the image editing model includes a first module, a second module, a third module, a linear layer corresponding to the third module, a de-noising network, a linear layer corresponding to the de-noising network, and a decoding module, S103 may specifically include updating some modules in the image editing model according to the difference between the image editing result corresponding to the original image and the edited image corresponding to the original image with respect to the editing description text, and the part of modules include some or all of the network layers in the second module, the third module, the linear layer corresponding to the third module, the de-noising network, and the linear layer corresponding to the noising network.

It should be noted that the present application does not limit the embodiment of “some or all of the network layers in the second module” in the above paragraph, and for example, when the second module is implemented using the reward module shown in FIG. 5, the “some or all of the network layers in the second module” may be an MLP.

In addition, in order to better improve the performance of the model, the present application also provides a possible embodiment of S103 above, in which S103 may specifically update some or all modules in the image editing model according to the difference between the image editing result corresponding to the original image and the edited image corresponding to the original image with respect to the editing description text, and return to and continue to execute S101 and the subsequent steps until the iterative training process for the image editing model is ended when the preset stop condition is reached.

The preset stop condition refers to a condition that needs to be achieved when the iterative training process for the image editing model is completed. Moreover, the present application does not limit the embodiment of the preset stop condition. For example, the preset stop condition may include that the model loss of the image editing model is lower than the preset loss threshold. As another example, the preset stop condition may include that a change rate of model loss of the image editing model is lower than a preset change rate threshold. For example, the preset stop condition may include that the number of times of updates of the image editing model reaches a preset number of times threshold.

Based on the related contents of S101 to S103 above, it can be seen that in the model training method provided by the present application, the original image, the editing description text corresponding to the original image, the edited image corresponding to the original image with respect to the editing description text, and evaluation information of the edited image are first obtained, so that the evaluation information is configured to describe the state of the edited image in at least one evaluation item, so that the evaluation information can indicate the shortcomings of the edited image, and the evaluation information can indicate the level required for image editing processing of the original image. Then processing the original image, the editing description text and the evaluation information by using the image editing model to obtain an image editing result corresponding to the original image; then, according to the difference between the image editing result and the edited image, the image editing model is updated, so that the updated model has better image editing performance, so that the image editing processing based on the model can achieve better effect.

The image editing model performs image editing processing according to the evaluation information, so that the image editing model can accurately obtain the following information with the assistance of the evaluation information: what level the image editing processing needs to achieve for the original image, and the information about the shortcomings of the image obtained by the image editing processing, etc., so that the image editing model can learn how to perform image editing processing with respect to the constraints described by the evaluation information, and then the image editing model can learn how to flexibly control the state of the output image in at least one evaluation item, so that the interference caused by the defect of the edited image in the training data can be effectively overcome, and the performance of the image editing model can be improved.

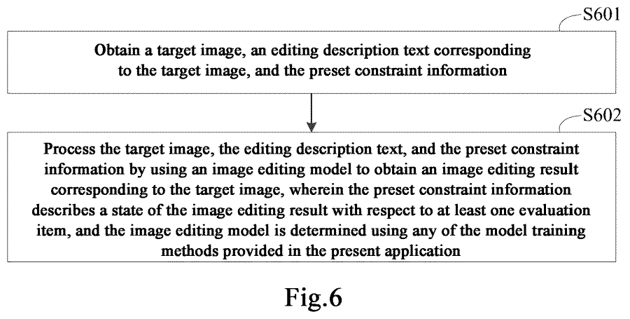

Based on the above-described content of the image editing model, the present application also provides an image editing method, which includes S601-S602 below, as shown in FIG. 6. FIG. 6 is a flowchart of an image editing method according to an embodiment of the present application.

S601: a target image, an edit description text corresponding to the target image, and preset constraint information are acquired.

Among them, the target image refers to an image provided by a user and required to be subjected to image editing processing. Moreover, the present application does not limit the acquiring method of the target image.

The editing description text corresponding to the target image refers to text provided by the user for describing what kind of editing processing is performed on the target image. Moreover, the present application does not limit the acquiring method of the edit description text. It should be noted that the embodiment of the editing description text corresponding to the target image is similar to the embodiment of the editing description text corresponding to the original image above.

The preset constraint information is configured to describe what level the image editing processing for the target image reaches with respect to at least one evaluation item, so that the preset constraint information indicates a state in which the image editing result obtained by the target image with respect to the editing description text corresponding to the target image is located with respect to at least one evaluation item.

In addition, the present application does not limit the embodiment of the above-described preset constraint information, and for example, the embodiment of the preset constraint information is similar to the embodiment of the above-described evaluation information.

In addition, the present application does not limit the method of acquiring the preset restriction information above, and in order to facilitate understanding, the description will be made below in combination with two cases.

In a first case, in the scenario where the requirement of the image editing effect is relatively high, the above preset constraint information can be implemented by using the information {5, 5, 5, None, None, None} set in advance for the trained image editing model, so as to ensure that the image editing processing for the target image is implemented at the highest level as possible, so as to ensure that the image editing result obtained for the target image is as optimal as possible, which is conducive to improving the image editing effect. Among them, the first 5 refers to the maximum value of the score of the text following the evaluation item. The second 5 refers to the maximum value of the score of the image preserving evaluation item. The third 5 refers to the maximum value of the score of the image quality evaluation item. The first None means that there is no defect in the image editing process with respect to the text following evaluation item. The second None means that there is no defect in the image editing process with respect to the image preserving evaluation item. The third None means that there is no defect in the image editing process with respect to the image quality evaluation item.

In a second case, in a scenario where the requirement of the image editing flexibility is relatively high, the above-described preset constraint information may be implemented using editing level description information provided by the user for the target image. Since the editing level description information refers to information specified by the user for describing what level the image editing process for the target image reaches with respect to at least one evaluation item, the editing level description information can describe the editing level requirement specified by the user for the target image, so that the image editing process realized based on the editing level description information can meet the requirement, and thus it is beneficial to improve the flexibility of image editing.

S602: the target image, the editing description text, and preset constraint information is processed by using an image editing model to obtain an image editing result corresponding to the target image, the preset constraint information is configured to describe a state of the image editing result with respect to at least one evaluation item, and the image editing model is determined by using any embodiment of the model training method provided by the present application.

It should be noted that the embodiment of S602 is similar to the embodiment of S102 above, and will not be described here for the sake of simplicity.

Based on the related contents of S601 to S602 above, it can be seen that in the image editing method provided by the present application, after the target image, the editing description text corresponding to the target image, and the preset constraint information is acquired, the image editing result corresponding to the target image is processed by the image editing model, so that the image editing result can satisfy the content editing constraint described by the editing description text, the editing level constraint described by the preset constraint information, and the content preserving constraint related to the target image, which is beneficial to improving the image editing effect.

Further, the present application does not limit the execution subject of the image editing method provided by the embodiment of the present application, and the image editing method provided by the embodiment of the present application may be applied to a terminal device or a server, for example. As another example, the image editing method provided by the embodiment of the present application may be implemented by means of a data interaction process between the terminal device and the server.

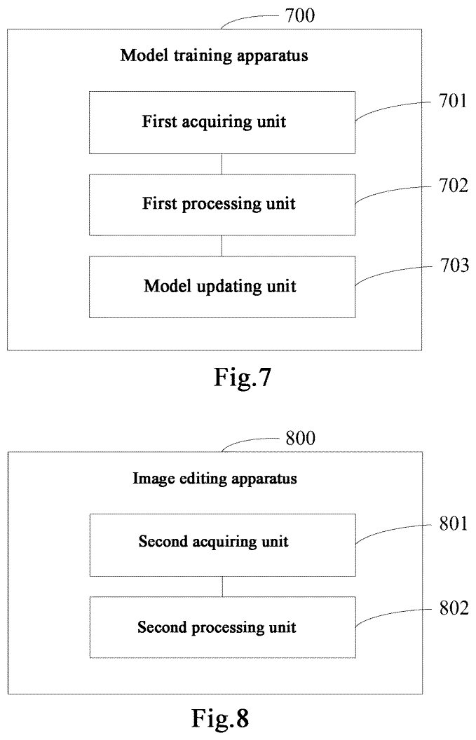

Based on the model training method provided by the embodiment of the present application, the embodiment of the present application further provides a model training device, which is explained and described below with reference to FIG. 7. FIG. 7 is a schematic structural diagram of a model training apparatus according to an embodiment of the present application. It should be noted that for technical details of the model training device provided by the embodiment of the present application, please refer to the related content of the above model training method.

As shown in FIG. 7, a model training device 700 according to an embodiment of the present application includes:
a first acquiring unit 701, configured to acquire an original image, an editing description text corresponding to the original image, an edited image corresponding to the original image with respect to the editing description text, and evaluation information of the edited image, wherein the evaluation information is configured to describe a state in which the edited image is located with respect to at least one evaluation item;
a first processing unit 702 is configured to process the original image, the editing description text, and the evaluation information by using an image editing model to obtain an image editing result corresponding to the original image;
a model updating unit 703 is configured to update the image editing model according to a difference between the image editing result and the edited image.

In a possible embodiment, the at least one evaluation item comprises one or more of a text following evaluation item, an image preserving evaluation item, and an image quality evaluation item. The text following evaluation item is configured to describe a matching state presented by the edited image and the edit description text on first content determined in accordance with at least one edit instruction described by the edit description text. The image preserving evaluation item is configured to describe a matching state between the edited image and the original image with respect to second content, the second content being determined based on content in the original image other than the first content. The image quality evaluation term is configured to describe a quality change of the edited image relative to the original image.

In a possible embodiment, the evaluation information comprises a score of each of the evaluation items, and/or the evaluation information comprises a defect description text of some or all of the evaluation items; For one of the evaluation items, the score of the one evaluation item is configured to characterize a level achieved by the edited image with respect to the evaluation item, and the defect description text of the evaluation item is configured to describe the defect of the edited image with respect to the evaluation item.

In a possible embodiment, the at least one evaluation item comprises one or more of a text following evaluation item, an image preserving evaluation item, and an image quality evaluation item. The score of the text following evaluation item is configured to describe a similarity degree between a change in content of the edited image relative to the original image and a change in content described by the edited description text. The score of the image preserving evaluation item is configured to describe a similarity degree between content retained by the edited image relative to the original image and content in the original image other than the edited content specified by the editing description text. The score of the image quality evaluation term is configured to describe a quality change of the edited image relative to the original image. The defect description text of the text following evaluation item is configured to describe at least one following error in the edited image relative to the edited description text. The defect description text of the image preserving evaluation item is configured to describe at least one preserving error of the edited image relative to the original image. The defect description text of the image quality evaluation item is configured to describe at least one quality defect of the edited image relative to the original image.

In one possible embodiment, the evaluation information is introduced into the de-noising network in the image editing model as condition information.

In a possible embodiment, for any of the cross-attention layers in the de-noising network, input data of a data fusion layer corresponding to the cross-attention layer is determined based on the evaluation information and output data of the cross-attention layer, and the input data of the cross-attention layer includes an encoding result of the edit description text.

In a possible embodiment, the input data of the data fusion layer is determined based on a feature vector of the evaluation information. The evaluation information includes at least one type of data, and a feature vector of the evaluation information is determined according to a vectorization result of each type of data and a vectorization result of each type.

In a possible embodiment, the data fusion layer is configured to calculate a residual error or calculate a sum value based on a mapping result of the output data of the cross-attention layer and the feature vector of the evaluation information in a first feature space, and the first feature space is a feature space to which the output data of the cross-attention layer belongs.

In a possible embodiment, input data of a de-noising network in the image editing model comprises first data and second data, the first data being input to the de-noising network as condition information, the input data of a first network layer in the de-noising network comprising the second data, the first data being different from the second data. The second data is determined based on the original image and the evaluation information.

In a possible embodiment, the determining process of the second data includes: performing concatenating processing on an image feature of the original image and noise addition result of an image feature of the edited image to obtain concatenating result; performing convolution processing on the concatenating result to obtain a convolution result; performing at least one cross-attention processing according to a mapping result between the convolution result and the feature vector of the evaluation information in a second feature space to obtain the second data, and the second feature space is a feature space to which the convolution result belongs.

In a possible embodiment, the image editing model includes a first module, a second module, a third module, a linear layer corresponding to the third module, a de-noising network, a linear layer corresponding to the de-noising network, and a decoding module. The first module is configured to obtain a concatenating result between an image feature of the original image and a noise addition result of an image feature of the edited image. The second module is configured to acquire a feature vector of the evaluation information. The linear layer corresponding to the third module and the linear layer corresponding to the de-noising network are configured to process the feature vector of the evaluation information. The third module is configured to perform at least one cross-attention processing according to the concatenating result and the output data of the linear layer corresponding to the third module. The de-noising network is configured to perform de-noising processing according to the output data of the third module, the encoding result of the editing description text, and the output data of the linear layer corresponding to the de-noising network. The decoding module is configured to perform decoding processing on the output data of the de-noising network to obtain the image editing result.

In a possible embodiment, the model updating unit 703 is specifically configured to update some modules in the image editing model according to a difference between the image editing result and the edited image, and the part of modules include some or all network layers in the second module, the third module, a linear layer corresponding to the third module, the de-noising network, and a linear layer corresponding to the de-noising network.

Based on the related content of the model training device 700, it can be seen that the working principle of the model training device 700 provided by the present application includes: first acquiring an original image, an editing description text corresponding to the original image, an edited image corresponding to the original image with respect to the editing description text, and evaluation information of the edited image, enabling the evaluation information to describe a state of the edited image in at least one evaluation item, so that the evaluation information can indicate a shortcoming of the edited image, and the evaluation information can indicate a level required for image editing processing of the original image. Then the original image, the editing description text and the evaluation information are processed by using the image editing model to obtain an image editing result corresponding to the original image. According to the difference between the image editing result and the edited image, the image editing model is updated, so that the updated model has better image editing performance, so that the image editing processing based on the model can achieve better effect. The image editing model performs image editing processing according to the evaluation information, so that the image editing model can accurately obtain the following information with the assistance of the evaluation information: what level the image editing processing needs to achieve for the original image, and the information about the shortcomings of the image obtained by the image editing processing, etc., so that the image editing model can learn how to perform image editing processing with respect to the constraints described by the evaluation information, and then the image editing model can learn how to flexibly control the state of the output image in at least one evaluation item, so that the interference caused by the defect of the edited image in the training data can be effectively overcome, and the performance of the image editing model can be improved.

Based on the image editing method provided by the embodiment of the present application, the embodiment of the present application further provides an image editing device, which will be explained and described below with reference to FIG. 8. FIG. 8 is a schematic structural diagram of an image editing apparatus according to an embodiment of the present application. For technical details of the image editing apparatus provided by the embodiment of the present application, please refer to the above-described image editing method.

As shown in FIG. 8, an image editing device 800 according to an embodiment of the present application includes:

A second acquiring unit 801, configured to acquire a target image, an editing description text corresponding to the target image, and preset constraint information;

The second processing unit 802 is configured to process the target image, the editing description text, and the preset constraint information by using an image editing model to obtain an image editing result corresponding to the target image, and the preset constraint information is configured to describe a state of the image editing result with respect to at least one evaluation item, and the image editing model is determined by using any embodiment of the model training method provided in the present application.

Based on the related content of the image editing apparatus 800 described above, it can be seen that the operation principle of the image editing apparatus 800 provided in the present application may be that after acquiring the target image, the editing description text corresponding to the target image, and the preset constraint information, the image editing result corresponding to the target image is processed by the image editing model, so that the image editing result can satisfy the content editing constraint described by the editing description text, the editing level constraint described by the preset constraint information, and the content preserving constraint related to the target image, which is beneficial to improving the image editing effect.

In addition, an embodiment of the present application further provides an electronic device, wherein the device includes a processor and a memory: the memory is used for storing instructions or a computer program. The processor is configured to execute the instructions or the computer program in the memory to cause the electronic device to execute any embodiment of the model training method provided by the embodiment of the present application, or to execute any embodiment of the image editing method provided by the embodiment of the present application.

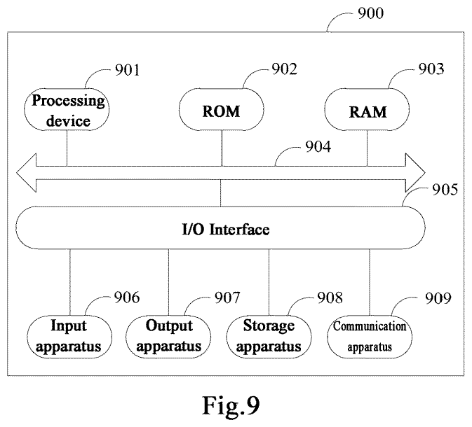

Referring to FIG. 9, a schematic structural diagram of an electronic device 900 suitable for implementing an embodiment of the present disclosure is shown. The terminal device in the embodiment of the present disclosure may include, but is not limited to, a mobile terminal such as a mobile phone, a notebook computer, a digital broadcast receiver, a PDA (Personal Digital Assistant), a PAD (Tablet Computer), a PMP (Portable Multimedia Player), an in-vehicle terminal (for example, an in-vehicle navigation terminal), and the like, and a fixed terminal such as a digital TV, a desktop computer, and the like. The electronic device illustrated in FIG. 9 is merely an example, and should not impose any limitation on the functions and scope of use of the embodiments of the present disclosure.

As shown in FIG. 9, the electronic device 900 may include a processing device (such as a central processing unit, a graphics processor, or the like) 901 that may perform various appropriate actions and processes according to a program stored in a read-only memory (ROM) 902 or a program loaded from a storage device 908 into a random access memory (RAM) 903. The RAM 903 also stores various programs and data necessary for the operation of the electronic device 900. The processing device 901, the ROM 902, and the RAM 903 are connected to each other by a bus 904. An input/output (I/O) interface 905 is also connected to the bus 904.

Generally, the following devices may be connected to the I/O interface 905: an input device 906 including, for example, a touch screen, a touch pad, a keyboard, a mouse, a camera, a microphone, an accelerometer, a gyroscope, and the like; An output device 907 including, for example, a liquid crystal display (LCD), a speaker, a vibrator, and the like; A storage device 908 including, for example, a magnetic tape, a hard disk, or the like; And a communication device 909. The communication device 909 may allow the electronic device 900 to communicate wirelessly or wired with other devices to exchange data. While FIG. 9 shows an electronic device 900 with various devices, it should be understood that it is not required that all of the devices shown be implemented or provided. More or fewer devices may alternatively be implemented or provided.

In particular, according to embodiments of the present disclosure, the processes described above with reference to the flowcharts may be implemented as computer software programs. For example, embodiments of the present disclosure include a computer program product comprising a computer program carried on a non-transitory computer-readable medium, the computer program including program code for performing the method shown in the flowchart. In such embodiments, the computer program may be downloaded and installed from a network via communication device 909, or installed from storage device 908, or installed from ROM 902. When the computer program is executed by the processing apparatus 901, the above-described functions defined in the method of the embodiment of the present disclosure are performed.

The electronic device provided by the embodiment of the present disclosure belongs to the same inventive concept as the method provided by the above-described embodiment, and the technical details not described in detail in the present embodiment can be referred to in the above-described embodiment, and the present embodiment has the same beneficial effects as the above-described embodiment.

Embodiments of the present application also provide a computer-readable medium, in which instructions or computer programs are stored, and when the instructions or computer programs are run on a device, the device executes any embodiment of the model training method provided by the embodiment of the present application or any embodiment of the image editing method provided by the embodiment of the present application.

The computer-readable medium of the present disclosure may be a computer-readable signal medium, a computer-readable storage medium, or any combination thereof. The computer-readable storage medium may be, for example, but is not limited to, an electrical, magnetic, optical, electromagnetic, infrared, or semiconductor system, apparatus, or device, or a combination of any of the above. More specific examples of computer-readable storage media may include, but are not limited to, an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the foregoing. In the present disclosure, a computer-readable storage medium may be any tangible medium containing or storing a program that may be used by or in conjunction with an instruction execution system, apparatus, or device. Whereas in the present disclosure, a computer-readable signal medium may comprise a data signal propagated in a baseband or as part of a carrier wave, carrying computer-readable program code therein. Such propagated data signals may take a variety of forms, including, but not limited to, electromagnetic signals, optical signals, or any suitable combination of the foregoing. The computer-readable signal medium may also be any computer-readable medium other than a computer-readable storage medium that may transmit, propagate, or transmit a program for use by or in connection with an instruction execution system, apparatus, or device. The program code contained on the computer-readable medium may be transmitted using any suitable medium, including, but not limited to, wires, optical cables, RF (radio frequency), or the like, or any suitable combination of the foregoing.

In some embodiments, the client, server may communicate using any currently known or future developed network protocol such as HTTP (Hyper Text Transfer Protocol), and may be interconnected with any form or medium of digital data communication (e.g., a communication network). Examples of communication networks include local area networks (“LAN”), wide area networks (“WAN”), the Internet (e.g., the Internet), and end-to-end networks (e.g., ad hoc end-to-end networks), as well as any currently known or future-developed networks.

The computer-readable medium may be included in the electronic device; It may also exist alone without being assembled into the electronic device.

The computer-readable medium carries one or more programs, and when the one or more programs are executed by the electronic device, the electronic device can execute the method.

Computer program code for performing the operations of the present disclosure may be written in one or more programming languages, or combinations thereof, including, but not limited to, object-oriented programming languages such as Java, Smalltalk, C++, but also conventional procedural programming languages such as the “C” language or similar programming languages. The program code may be executed entirely on the user's computer, partially on the user's computer, as a standalone software package, partially on the user's computer and partially on a remote computer, or entirely on a remote computer or server. In cases involving a remote computer, the remote computer may be connected to the user computer through any kind of network, including a local area network (LAN) or a wide area network (WAN), or may be connected to an external computer (e.g., using an Internet service provider to connect over the Internet).

The flowcharts and block diagrams in the drawings illustrate the architecture, functionality, and operation of possible implementations of systems, methods, and computer program products in accordance with various embodiments of the present disclosure. In this regard, each block in the flowchart or block diagram may represent a module, program segment, or portion of code that contains one or more executable instructions for implementing a specified logical function. It should also be noted that, in some alternative implementations, the functions noted in the blocks may also occur in a different order than that noted in the figures. For example, two blocks represented in succession may actually be executed substantially in parallel, and they may sometimes be executed in reverse order, depending on the function involved. It is also noted that each block in the block diagrams and/or flowchart diagrams, and combinations of blocks in the block diagrams and/or flowchart diagrams, may be implemented with a dedicated hardware-based system that performs the specified functions or operations, or may be implemented with a combination of dedicated hardware and computer instructions.

The units described in the embodiments of the present disclosure may be implemented by software or hardware. Here, the name of the unit/module does not constitute a limitation of the unit itself in some cases.

The functions described above herein may be performed, at least in part, by one or more hardware logic components. For example, and without limitation, exemplary types of hardware logic components that may be used include: a field programmable gate array (FPGA), an application specific integrated circuit (ASIC), an application specific standard product (ASSP), a system-on-chip (SOC), a complex programmable logic device (CPLD), and the like.

In the context of the present disclosure, a machine-readable medium may be a tangible medium that may contain or store a program for use by or in conjunction with an instruction execution system, apparatus, or apparatus. The machine readable medium may be a machine readable signal medium or a machine readable storage medium. The machine-readable medium may include, but is not limited to, electronic, magnetic, optical, electromagnetic, infrared, or semiconductor systems, devices, or devices, or any suitable combination of the foregoing. More specific examples of machine-readable storage media may include one or more line-based electrical connections, portable computer disks, hard disks, random access memory (RAM), read-only memory (ROM), erasable programmable read-only memory (EPROM or flash memory), optical fibers, handy compact disk read-only memory (CD-ROM), optical storage devices, magnetic storage devices, or any suitable combination of the foregoing.

It should be noted that, in the present specification, each embodiment is described in a stepwise manner, and each embodiment focuses on differences from other embodiments, and the same and similar parts between the embodiments may be referred to each other. For the system or device disclosed in the embodiment, since the system or device corresponds to the method disclosed in the embodiment, the description is relatively simple, and the description of the method section can be referring to for related details.

It should be understood that in the present application, “at least one” refers to one or more, and “a plurality” refers to two or more. “And/or” is configured to describe the association relationship of the association object, and means that there can be three relationships. For example, “A and/or B” can mean that only A exists, only B exists, and three cases of A and B exist at the same time, where A and B may be singular or plural. The character “/” generally indicates that the associated objects before and after are an “or” relationship. “At least one of the following” or a similar expression thereof refers to any combination of these items, including any combination of single or plural items. For example, at least one(s) of a, b, or c may represent: a, b, c, “a and b”, “a and c”, “b and c”, or “a and b and c”, wherein a, b, c may be single or multiple.

It should also be noted that, herein, relational terms such as first and second are used only to distinguish one entity or operation from another entity or operation, and do not necessarily require or imply any such actual relationship or order between the entities or operations. Moreover, the terms “comprising,” “comprising,” or any other variation thereof are intended to encompass a non-exclusive inclusion such that a process, method, article, or apparatus that includes a series of elements includes not only those elements, but also other elements that are not explicitly listed, or elements inherent to such a process, method, article, or apparatus. Without further limitation, an element defined by the statement “comprising a” does not preclude the presence of additional identical elements in a process, method, article, or apparatus comprising the element.

The steps of the methods or algorithms described in connection with the embodiments disclosed herein may be implemented directly in hardware, processor-executed software modules, or a combination of both. The software module may be placed in random access memory (RAM), memory, read-only memory (ROM), electrically programmable ROM, electrically erasable programmable ROM, registers, hard disk, removable magnetic disk, CD-ROM, or any other form of storage medium known in the art.

The above description of the disclosed embodiments enables those skilled in the art to implement or use the present application. Various modifications to these embodiments will be apparent to those skilled in the art, and the general principles defined herein may be implemented in other embodiments without departing from the spirit or scope of the present application. Accordingly, the present application will not be limited to the embodiments shown herein, but is intended to be accorded the widest scope consistent with the principles and novel features disclosed herein.

I/We claim:

1. A model training method, comprising:
acquiring an original image, an editing description text corresponding to the original image, an edited image corresponding to the original image with respect to the editing description text, and evaluation information of the edited image, wherein the evaluation information is configured to describe a state of the edited image with respect to at least one evaluation item;
processing the original image, the editing description text and the evaluation information by using an image editing model to obtain an image editing result corresponding to the original image; and
updating the image editing model according to a difference between the image editing result and the edited image.

2. The method of claim 1, wherein the at least one evaluation item comprises one or more of: a text following evaluation item, an image preserving evaluation item, and an image quality evaluation item;
the text following evaluation item is configured to describe a matching state presented between the edited image and the edit description text with respect to first content, wherein the first content is determined in accordance with at least one edit instruction described by the edit description text;
the image preserving evaluation item is configured to describe a matching state presented between the edited image and the original image with respect to second content, wherein the second content is determined based on content in the original image other than the first content; and
the image quality evaluation item is configured to describe a quality change of the edited image relative to the original image.

3. The method of claim 1, wherein the evaluation information comprises a score of each of the evaluation items, and/or the evaluation information comprises a defect description text of some or all of the evaluation items;
for one of the evaluation items, the score of the evaluation item is configured to characterize a level achieved by the edited image with respect to the one evaluation item, and the defect description text of the one evaluation item is configured to describe the defect of the edited image with respect to the evaluation item.

4. The method of claim 3, wherein the at least one evaluation item comprises one or more of: a text following evaluation item, an image preserving evaluation item, or an image quality evaluation item;
a score of the text following evaluation item is configured to describe a similarity degree between a change in content of the edited image relative to the original image and a change in content described by the edited description text;
a score of the image preserving evaluation item is configured to describe a similarity degree between content retained by the edited image relative to the original image and content in the original image other than the edited content specified by the editing description text;
a score of the image quality evaluation term is configured to describe a quality change of the edited image relative to the original image;
a defect description text of the text following evaluation item is configured to describe at least one following error of the edited image relative to the edited description text;
a defect description text of the image preserving evaluation item is configured to describe at least one preserving error of the edited image relative to the original image; and
a defect description text of the image quality evaluation item is configured to describe at least one quality defect of the edited image relative to the original image.

5. The method of claim 1, wherein the evaluation information is introduced as condition information into a de-noising network in the image editing model.

6. The method of claim 5, wherein for one of the cross-attention layers in the de-noising network, input data of a data fusion layer corresponding to the one cross-attention layer is determined based on the evaluation information and output data of the one cross-attention layer, and the input data of the one cross-attention layer comprises an encoding result of the editing description text.

7. The method of claim 6, wherein the input data of the data fusion layer is determined based on a feature vector of the evaluation information;
the evaluation information comprises at least one type of data, and the feature vector of the evaluation information is determined according to a vectorization result of each type of data and a vectorization result of each type.

8. The method of claim 6, wherein the data fusion layer is configured to perform residual error calculation or sum value calculation according to the output data of the cross-attention layer and a mapping result of a feature vector of the evaluation information in a first feature space, and the first feature space is a feature space to which the output data of the cross-attention layer belongs.

9. The method of claim 1, wherein input data of a de-noising network in the image editing model comprises first data and second data, the first data is input to the de-noising network as condition information, input data of a first network layer in the de-noising network comprises the second data, the first data is different from the second data;
the second data is determined based on the original image and the evaluation information.

10. The method of claim 9, wherein a determination process of the second data comprises:
performing concatenating processing on the image feature of the original image and the noise addition result of the image feature of the edited image to obtain a concatenating result;
performing convolution processing on the concatenating result to obtain a convolution result; and
performing at least one cross-attention processing according to the convolution result and a mapping result of a feature vector of the evaluation information in a second feature space to obtain the second data, wherein the second feature space is a feature space to which the convolution result belongs.

11. The method of claim 1, wherein the image editing model comprises a first module, a second module, a third module, a linear layer corresponding to the third module, a de-noising network, a linear layer corresponding to the de-noising network, and a decoding module;
the first module is configured to obtain a concatenating result between an image feature of the original image and a noise addition result of an image feature of the edited image;
the second module is configured to acquire a feature vector of the evaluation information;
the linear layer corresponding to the third module and the linear layer corresponding to the de-noising network are configured to process the feature vector of the evaluation information;
the third module is configured to perform at least one cross-attention processing according to the concatenating result and the output data of the linear layer corresponding to the third module;
the de-noising network is configured to perform de-noising processing according to the output data of the third module, the encoding result of the editing description text, and the output data of the linear layer corresponding to the de-noising network; and
the decoding module is configured to perform decoding processing on the output data of the de-noising network to obtain the image editing result.

12. The method of claim 11, wherein updating the image editing model comprises:
updating a part of modules in the image editing model, wherein the part of modules comprises some or all network layers in the second module, the third module, the linear layer corresponding to the third module, the de-noising network, and the linear layer corresponding to the de-noising network.

13. The method of claim 1, further comprising:
acquiring a target image, an edit description text corresponding to the target image, and preset constraint information; and
processing the target image, the editing description text, and the preset constraint information by using the image editing model to obtain an image editing result corresponding to the target image, wherein the preset constraint information is configured to describe a state of the image editing result with respect to at least one evaluation item.

14. An electronic device comprising: a processor and a memory;
wherein the memory is configured to store instructions or a computer program; and
the processor is configured to execute the instructions or the computer program in the memory to cause the electronic device to:
acquire an original image, an editing description text corresponding to the original image, an edited image corresponding to the original image with respect to the editing description text, and evaluation information of the edited image, wherein the evaluation information is configured to describe a state of the edited image with respect to at least one evaluation item;
process the original image, the editing description text and the evaluation information by using an image editing model to obtain an image editing result corresponding to the original image; and
update the image editing model according to a difference between the image editing result and the edited image.

15. The electronic device of claim 14, wherein the at least one evaluation item comprises one or more of: a text following evaluation item, an image preserving evaluation item, and an image quality evaluation item;
the text following evaluation item is configured to describe a matching state presented between the edited image and the edit description text with respect to first content, wherein the first content is determined in accordance with at least one edit instruction described by the edit description text;
the image preserving evaluation item is configured to describe a matching state presented between the edited image and the original image with respect to second content, wherein the second content is determined based on content in the original image other than the first content; and
the image quality evaluation item is configured to describe a quality change of the edited image relative to the original image.

16. The electronic device of claim 14, wherein the evaluation information comprises a score of each of the evaluation items, and/or the evaluation information comprises a defect description text of some or all of the evaluation items;
for one of the evaluation items, the score of the evaluation item is configured to characterize a level achieved by the edited image with respect to the one evaluation item, and the defect description text of the one evaluation item is configured to describe the defect of the edited image with respect to the evaluation item.

17. The electronic device of claim 16, wherein the at least one evaluation item comprises one or more of: a text following evaluation item, an image preserving evaluation item, or an image quality evaluation item;
a score of the text following evaluation item is configured to describe a similarity degree between a change in content of the edited image relative to the original image and a change in content described by the edited description text;
a score of the image preserving evaluation item is configured to describe a similarity degree between content retained by the edited image relative to the original image and content in the original image other than the edited content specified by the editing description text;
a score of the image quality evaluation term is configured to describe a quality change of the edited image relative to the original image;
a defect description text of the text following evaluation item is configured to describe at least one following error of the edited image relative to the edited description text;
a defect description text of the image preserving evaluation item is configured to describe at least one preserving error of the edited image relative to the original image; and
a defect description text of the image quality evaluation item is configured to describe at least one quality defect of the edited image relative to the original image.

18. The electronic device of claim 14, wherein the evaluation information is introduced as condition information into a de-noising network in the image editing model.

19. The electronic device of claim 18, wherein for one of the cross-attention layers in the de-noising network, input data of a data fusion layer corresponding to the one cross-attention layer is determined based on the evaluation information and output data of the one cross-attention layer, and the input data of the one cross-attention layer comprises an encoding result of the editing description text.

20. A non-transitory computer-readable medium having instructions or computer programs stored therein that, when executed on a device, cause the device to:
acquire an original image, an editing description text corresponding to the original image, an edited image corresponding to the original image with respect to the editing description text, and evaluation information of the edited image, wherein the evaluation information is configured to describe a state of the edited image with respect to at least one evaluation item;
process the original image, the editing description text and the evaluation information by using an image editing model to obtain an image editing result corresponding to the original image; and
update the image editing model according to a difference between the image editing result and the edited image.
